(19) United States
(12) Patent Application Publication
(10) Pub. No.: US 2010/0079432 A1
(43) Pub. Date: Apr. 1, 2010

(54) DISPLAY APPARATUS AND METHOD THEREOF

(75) Inventors: Sang-hoon Kang, Suwon-si (KR); Sung-kyo Lee, Hwaseong-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 12/510,337

(22) Filed: Jul. 28, 2009

(30) Foreign Application Priority Data
Sep. 26, 2008 (KR) 10-2008-0094811

(51) Int. Cl. G09G 5/00

(52) U.S. Cl. 345/211

(57) ABSTRACT

A display apparatus and a method thereof are provided. The display apparatus includes a first controller which displays an image corresponding to a video signal, a main power supply unit, a second controller which determines whether to interrupt power supply from the main power supply unit, and a secondary power supply unit. Accordingly, power consumption in the display apparatus is reduced.

### CROSS-REFERENCE TO RELATED APPLICATIONS

This application claims priority from Korean Patent Application No. 10-2008-94811, filed Sep. 26, 2008, in the Korean Intellectual Property Office, the entire disclosure of which is hereby incorporated by reference.

### BACKGROUND OF THE INVENTION

1. Field of the Invention

Methods and apparatuses consistent with the present invention relate to displaying an image, and more particularly, displaying an image received from an external device.

2. Description of the Related Art

As a display apparatus, a monitor is mainly used to display an image received from a personal computer (PC). Such a monitor consumes power to display an image even when a user does not actually use it, which hinders power saving effect.

In order to address this problem, a display power management signaling (DMPS) function has come into existence. According to the DMPS function, if a user input is not made through a user input device such as a keyboard or a mouse for a long time, the PC controls the monitor to enter a power saving mode and not to display an image on the monitor.

However, even if the DMPS function is performed as the monitor enters the power saving mode, a control element provided in the monitor is still maintained in a normal mode, which causes unnecessary power consumption.

Therefore, there is a demand for a method of reducing power consumption after the monitor enters a power saving mode.

### SUMMARY OF THE INVENTION

Exemplary embodiments of the present invention overcome the above disadvantages and other disadvantages not described above. Also, the present invention is not required to overcome the disadvantages described above, and an exemplary embodiment of the present invention may not overcome any of the problems described above.

The present invention provides a display apparatus which reduce power consumption after the display apparatus enters a power saving mode and a method thereof.

According to an aspect of the present invention, there is provided a display apparatus which receives a video signal from an external device, the display apparatus including, a first controller which controls operation of the display apparatus and displays an image corresponding to the video signal, a main power supply unit which supplies the first controller with main power, a second controller which determines whether to interrupt power supply to the first controller from the main power supply unit based on the video signal, and a secondary power supply unit which supplies the second controller with secondary power.

The display apparatus may further include a switch unit, and the second controller may control the switch unit based on the video signal to interrupt or not to interrupt power supply from the main power supply unit.

The second controller may interrupt power supply from the main power supply unit if a video signal received from the external device is an abnormal video signal.

The second controller may be operated in a standby mode if a video signal received from the external device is an abnormal video signal.

The standby mode is that if the video signal is a normal video signal, the main power is supplied to the first controller.

The video signal may be determined to be an abnormal video signal if the video signal does not contain either a horizontal synchronization signal or a vertical synchronization signal or both of them.

The display apparatus may be a monitor and the external device may be a computer.

The first controller and the second controller may be integrated into a single control element.

The main power supply unit and the secondary power supply unit may be integrated into a single power supply element.

According to another aspect of the present invention, there is provided a display method of a display apparatus which receives a video signal from an external device and controls operation of the display apparatus, the display method including receiving the video signal, supplying a first controller with main power to display an image corresponding to the video signal, supplying a second controller with secondary power to determine whether to interrupt supply of the main power, and based on the video signal, determining whether to interrupt supply of the main power.

The determining may determine whether to interrupt supply of the main power by controlling a switch unit based on the video signal.

The determining may include interrupting supply of the main power if a video signal received from the external device is an abnormal video signal.

The display method may further include converting a mode of the second controller into a standby mode if the video signal received from the external device is an abnormal video signal.

The standby mode is that if the video signal is a normal video signal, the main power is supplied to the first controller.

The video signal may be determined to be an abnormal video signal if the video signal does not contain either a horizontal synchronization signal or a vertical synchronization signal or both of them.

The first controller and the second controller may be integrated into a single control element.

The main power supply unit and the secondary power supply unit may be integrated into a single power supply element.

### BRIEF DESCRIPTION OF THE DRAWINGS

The above and/or other aspects of the present invention will be more apparent by describing certain exemplary embodiments of the present invention with reference to the accompanying drawings, in which:

FIG. 1 is a block diagram illustrating a display apparatus according to an exemplary embodiment of the present invention; and

FIG. 2 is a flowchart illustrating a display method according to an exemplary embodiment of the present invention.

### DETAILED DESCRIPTION OF EXEMPLARY EMBODIMENTS

Certain exemplary embodiments of the present invention will be described in greater detail with reference to the accompanying drawings.

In the following description, the same drawing reference numerals are used for the same elements even in different drawings. The matter defined in the description, such as detailed construction and elements, are provided to assist in a comprehensive understanding of the invention. Thus, it is apparent that the exemplary embodiments of the present invention can be carried out without this specifically defined matter. Also, well-known functions or constructions are not described in detail since they would obscure the invention with unnecessary detail.

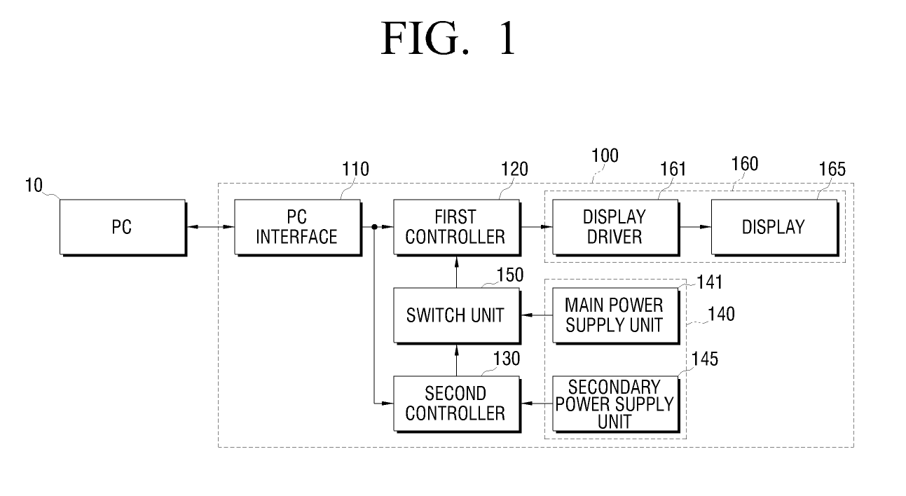

FIG. 1 is a block diagram illustrating a monitor 100 according to an exemplary embodiment of the present invention. The monitor 100 according to an exemplary embodiment of the present invention is types of display apparatuses that display an image received from a personal computer (PC) 10. The PC 10 has a display power management signaling (DMPS) function. The DMPS function refers to a function that the PC 10 controls the monitor 100 to reduce power consumption therein.

As shown in FIG. 1, the monitor 100 comprises a PC interface 110, a first controller 120, a second controller 130, a power supply unit 140, a switch unit 150, and a display panel 160.

The PC interface 110 is connected to the PC 10 to communicate therewith according to a D-Sub communication scheme or digital video interface (DVI) communication scheme and receives an image from the PC 10 connected to the PC interface 110.

The power supply unit 140 comprises a main power supply unit 141 and a secondary power supply unit 145. The main power supply unit 141 supplies the first controller 120 with main power to perform entire operation of the monitor, and the secondary power supply unit 145 supplies the second controller 130 with power.

The main power supply unit 141 is supplied with power of 5V and the secondary power supply unit 145 is supplied with power of 3.3V.

The first controller 120 is supplied with power from the main power supply unit 141 and controls entire operation of the monitor 100, and performs operations of receiving a video signal received from the PC 10 through the PC interface 110 and controlling the displaying of an image corresponding to the received video signal.

The first controller 120 scales a resolution of the image received from the PC 10 through the PC interface 110 to conform to a resolution of a display 165 which will be described below. The first controller 120 comprises a scaler to perform a scaling function. The first controller 10 transmits a scaled image to the display panel 160.

The display panel 160 comprises a display driver 161 and the display 165. The display driver 161 displays the image scaled by the first controller 120 on the display 165. Accordingly, the display 165 displays an image that is received from the PC 10 through the PC interface 110 and then is scaled by the first controller 120.

The second controller 130 is supplied with power from the secondary power supply unit 145 and controls the switch unit 150. The switch unit 150 is controlled by the second controller 130 to perform a switching operation to determine whether to supply power to the first controller 120 from the main power supply unit 141.

The second controller 130 controls the switch unit 150 based on a video signal received from the PC 10 through the PC interface 110 to convert a power mode of the monitor 100.

More specifically, if an abnormal video signal is received from the PC 10 through the PC interface 110, the second controller 130 converts the mode of the monitor 100 into a power saving mode. In order to convert the mode of the monitor 100 to the power saving mode, the second controller 130 controls the switch unit 150 not to supply power to the first controller 120. That is, the second controller 130 converts the mode of the first controller 120 into a power saving mode and eventually converts the mode of the monitor 100 into a power saving mode.

In the power saving mode, no image is displayed through the display 165 of the monitor 100. Therefore, the second controller 130 interrupts power supply to the first controller 10 such that the mode of the monitor 100 is converted into the power saving mode.

If the monitor 100 is in the power saving mode, the second controller 130 performs a basic function, such as receiving a video signal from the PC 10 through the PC interface 110 and transmitting the video signal, and a function of determining whether a normal video signal is received from the PC 10 through the PC interface 110 and generating and transmitting a command to return the first controller 120 to the normal mode.

A video signal received from the PC 10 is determined to be abnormal if the video signal received from the PC 10 through the PC interface 110 does not contain either a horizontal synchronization (Hsync) signal or a vertical synchronization (Vsync) signal or both of them. That is, if the PC 10 does not transmit either the Hsync signal or the Vsync signal or both of them to the monitor 100, an abnormal video signal is received from the PC 10.

If an abnormal video signal is received from the PC through the PC interface 110, the second controller 130 enters a standby mode. During the standby mode, if a normal video signal is received from the PC 10, the second controller 130 requests (commands) the first controller 120 to enter a normal mode and controls the switch unit 150 to supply power from the main power supply unit 141 to the first controller 120.

That is, the second controller 130 receives a video signal from the PC 10 through the PC interface 110, and when entering the standby mode, the second controller 130 continues detecting whether a normal video signal is received from the PC 10 through the PC interface 110. Herein the normal video signal refers to a video signal containing both of the Hsync signal and the Vsync signal.

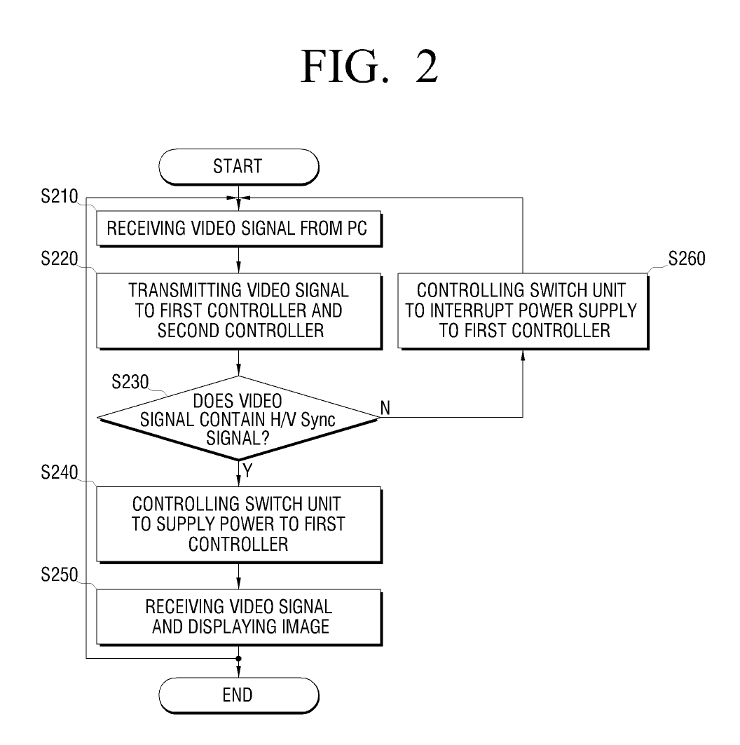

Hereinafter, a process of operating the monitor 100 shown in FIG. 1 in a power saving mode or a normal mode will be explained in detail with reference to FIG. 2. FIG. 2 is a flowchart illustrating a display method according to an exemplary embodiment of the present invention.

Referring to FIG. 2, the PC interface 110 receives a video signal from the PC 10 (S210), and transmits the received video signal to the first controller 120 and the second controller 130.

The second controller 130 analyzes the received video signal to determine whether the video signal contains the Hsync signal and the Vsync signal or not (S230).

If it is determined that the video signal contains both of the Hsync signal and the Vsync signal (S230-Y), the second controller 130 controls the switch unit 150 such that power supplied from the main power supply unit 141 is transmitted to the first controller 120 (S240).

The first controller 120 is supplied power from the switch unit 150, scales an image received from the PC 10 through the PC interface, and transmits the image to the display panel 160 to display the image (S250).

As described above, as power for controlling entire operation of the monitor 100 is supplied to the first controller 120, the monitor 100 is operated in a normal mode.

If it is determined that the video signal does not contain either one of the Hsync signal and the Vsync signal or both of them (S230-N), the second controller 130 controls the switch unit 150 not to supply power from the main power supply unit 141 to the first controller 120 (S260).

Next, the second controller 130 determines whether the video signal received from the PC 10 contains the Hsync signal and the Vsync signal and repeat the above operations, so that a power saving mode of the monitor 100 is maintained or the monitor 100 is returned to a normal mode.

As described, no power is supplied to the first controller 120 controlling entire operation of the monitor 100 so that the monitor 100 can enter a power saving mode and accordingly power consumption can be minimized.

Even if the monitor 100 enters a power saving mode, the second controller 130 is operated in the standby mode to control whether to supply power to the first controller 120. Therefore, if it is determined that the video signal contains both of the Hsync signal and the Vsync signal, the second controller 130 directly converts the mode of the monitor 100 into a normal mode.

The monitor 100 mentioned in the above embodiments is merely an example of a display apparatus. Therefore, the technical idea of the present invention will be applicable to a different type display apparatus beside the monitor.

In the above descriptions, the power supply unit 140 is divided into the main power supply unit 141 and the secondary power supply unit 145. However, this is merely an example for convenience of explanation. Therefore, the technical idea of the present invention will be applicable to the case where the power supply unit 140 is operated as a single power supply unit 140 rather than being divided into the main power supply unit 141 and the secondary power supply unit 145.

Also, the switch unit 150 is provided separately from the power supply unit 140. However, this is merely an example and the technical idea of the present invention will be applicable to the case where the switch unit 150 is integrated into the power supply unit 140.

Also, the first controller 120 and the second controller 130 are separate elements but this is merely an example. Therefore, the first controller 120 and the second controller 130 may be integrated into a single control element. In this case, a part of the single control element corresponds to the first controller 120, and the other part of the single control element corresponds to the second controller 130. Of course, a same part of the single control element may correspond to the first controller 120 and the second controller 130.

In the above exemplary embodiments, the switch unit 150 is provided to determine whether to supply power from the main power supply unit 141. However, this is merely an example for convenience of explanation. Therefore, the technical idea of the present invention will be applicable to the case where the second controller 130 controls the main power supply unit 141 to directly supply power to the first controller 120 or not.

In the above exemplary embodiments, the monitor 100 displays an image received from the PC 10. However, the technical idea of the present invention will be applicable to the case where an image is received from a different device besides the PC 10.

As described above, a control element for controlling the entire operation of the display apparatus is controlled by a separate control element such that power consumption is reduced after the display apparatus enters a power saving mode.

The foregoing exemplary embodiments and advantages are merely exemplary and are not to be construed as limiting the present invention. The present teaching can be readily applied to other types of apparatuses. Also, the description of the exemplary embodiments of the present invention is intended to be illustrative, and not to limit the scope of the claims, and many alternatives, modifications, and variations will be apparent to those skilled in the art.

What is claimed is:

1. A display apparatus which receives a video signal from an external device, the display apparatus comprising:
a first controller which controls operation of the display apparatus and controls a displaying of an image corresponding to the video signal;
a main power supply unit which supplies the first controller with main power;
a second controller which determines whether to interrupt a supply of main power to the first controller from the main power supply unit based on the video signal; and
a secondary power supply unit which supplies the second controller with secondary power.

2. The display apparatus as claimed in claim 1 further comprising a switch unit,
wherein the second controller controls the switch unit based on the video signal to interrupt or not to interrupt the supply of main power from the main power supply unit.

3. The display apparatus as claimed in claim 1, wherein the second controller interrupts the supply of main power from the main power supply unit if the video signal received from the external device is an abnormal video signal.

4. The display apparatus as claimed in claim 1, wherein the second controller is operated in a standby mode if the video signal received from the external device is an abnormal video signal.

5. The display apparatus as claimed in claim 4, wherein the standby mode is that if the video signal is a normal video signal, the main power is supplied to the first controller.

6. The display apparatus as claimed in claim 3, wherein the video signal is determined to be the abnormal video signal if the video signal does not contain at least one of a horizontal synchronization signal and a vertical synchronization signal.

7. The display apparatus as claimed in claim 1, wherein the display apparatus is a monitor and the external device is a computer.

8. The display apparatus as claimed in claim 1, wherein the first controller and the second controller are integrated into a single control element.

9. The display apparatus as claimed in claim 1, wherein the main power supply unit and the secondary power supply unit are integrated into a single power supply element.

10. A display method of a display apparatus which receives a video signal from an external device and controls operation of the display apparatus, the display method comprising:
receiving the video signal;
supplying a first controller with main power to display an image corresponding to the video signal; and
supplying a second controller with secondary power to determine whether to interrupt the supplying of the first controller with the main power in a determining,
wherein the determining whether to interrupt the supply of the main power is based on the video signal.

11. The display method as claimed in claim 10, wherein the determining determines whether to interrupt the supplying the first controller with the main power by a switch unit, based on the video signal.

12. The display method as claimed in claim 10, wherein the determining comprises interrupting the supplying the first controller with the main power if the video signal received from the external device is an abnormal video signal.

13. The display method as claimed in claim 10, further comprising converting a mode of the second controller into a standby mode if the video signal received from the external device is an abnormal video signal.

14. The display method as claimed in claim 13, wherein the standby mode is that if the video signal is a normal video signal, the main power is supplied to the first controller.

15. The display method as claimed in claim 12, wherein the video signal is determined to be an abnormal video signal if the video signal does not contain at least one of a horizontal synchronization signal and a vertical synchronization signal.

16. The display method as claimed in claim 10, wherein the first controller and the second controller are integrated into a single control element.

17. The display method as claimed in claim 10, wherein the main power supply unit and the secondary power supply unit are integrated into a single power supply element.

18. The display apparatus of claim 1 further comprising a PC interface interfacing the display apparatus with the external device; and
a switch unit which receives the main power from the main power supply unit and is disposed between the first and the second controllers,
wherein the first controller performs a scaling function on the video signal,
the first and the second controllers receive the video signal from the PC interface in parallel, and
the switch unit interrupts the supply of the main power to the first controller based on the second controller determining that the video signal does not contain at least one of a horizontal synchronization signal and a vertical synchronization signal.

19. The display apparatus of claim 18 further comprising a display panel, the display panel comprising a display driver, wherein the first controller is connected to the display driver to control the displaying.

20. The display method of claim 10, wherein the receiving the video signal comprises receiving the video signal at a PC interface, and receiving in parallel, the video signal from the PC interface at the first and the second controllers,
the supplying the first controller with the main power comprises receiving the main power at a switch unit and supplying the main power to the first controller from the switch unit, and
the determining comprises determining that the supplying the first controller with the main power is to be interrupted based on the second controller determining that the video signal does not contain at least one of a horizontal synchronization signal and a vertical synchronization signal, and
the display method further comprises controlling the switch unit by the second controller to interrupt the supplying the first controller with the main power.
